(19) United States
(12) Patent Application Publication
(10) Pub. No.: US 2008/0143075 A1
(43) Pub. Date: Jun. 19, 2008

(54) Therapeutic wheelchair system

(76) Inventor: William L. Schramm, McKees Rocks, PA (US)

Correspondence Address: William L. Krayer, 1771 Helen Drive, Pittsburgh, PA, 15216, US

(21) Appl. No.: 11/641,393

(22) Filed: Dec. 19, 2006

(51) Int. Cl. A61G 5/10; A47C 7/50

(52) U.S. Cl. 280/304.1; 297/423.1

(57) ABSTRACT

A wheelchair station is provided for a wheelchair. The station system includes motors, gears, and other heavy devices so the wheelchair itself can remain relatively light in weight. When the wheelchair is backed into the wheelchair station and engages, the occupant can elevate his or her feet by devices in the wheelchair station; the occupant can also operate reclining mechanisms. The wheelchair is designed so its backrest can nest into the backrest of the back of the wheelchair station; the backrests will pivot to recline together. A tipping means is also provided so the entire wheelchair station, including the wheelchair and its occupant, can be tilted backwards while the occupant is in the supine position, to elevate the feet higher than the head. The system is useful for therapeutic purposes, to elevate the legs, to relieve the accumulation of fluid in the legs, to aid blood circulation, and for relieving stress on the back and neck. The system also gives aid to the occupant to assume positions necessary for various types of exercises and stretches. It will also enable a person who may have fallen off the wheelchair while not in the wheelchair station and is on the floor; the rescue feature will elevate the person from floor level to wheelchair seat height for easy transfer back onto the wheelchair. The system provides greater freedom of action and choice to persons who use wheelchairs.

### TECHNICAL FIELD

The invention pertains to a wheelchair station equipped to receive a wheelchair while occupied by a person, facilitate a reclining position for the person and elevate the person's feet while in the wheelchair. The wheelchair station may be used for therapeutic purposes where elevation of the feet is indicated to aid circulation, as a unit of domestic furniture for watching TV or the like, for cosmetic purposes as an aid to a barber or hairdresser, for positioning a patient for dental or medical services, or for relieving stress on the back. A wheelchair is designed specially or may be retrofitted for use in the wheelchair station.

### BACKGROUND OF THE INVENTION

A person using a conventional wheelchair without an external apparatus of any kind must repair to the bed in order to elevate his or her legs. If somehow a person is placed on a conventional reclining chair in order to elevate the feet or legs to the extent possible on the reclining chair, it is not unlikely that the person's legs, lacking any ability for self-movement, or subject to spasms, can become squeezed in the space between the foot holder and the space above it, causing extreme pain, injury, or inconvenience.

There is a need for an accessible, versatile apparatus for manipulating a wheelchair so that the occupant can elevate the legs and/or feet to assist with circulation, relieve the accumulation of fluid in the legs, and/or assume positions necessary for situps and other exercises in place, as well as achieve a comfortable reclining or semi-reclining position for watching TV, reading, or taking a nap.

In the past, wheelchairs and devices for manipulating wheelchairs have been suggested for tilting a person in a wheelchair backwardly not only for comfort or therapeutic purposes, but also in order to facilitate dentistry, or for washing the hair and other cosmetic purposes. Such devices that are part of the wheelchair itself include the descriptions by Wood, U.S. Pat. No. 4,591,182, Mizelle, U.S. Pat. No. 5,348,367, Galloway, U.S. Pat. No. 6,158,810, Patterson U.S. Pat. No. 5,044,647, Pulver U.S. Pat. No. 6,425,635, Koerlin et al U.S. Pat. No. 6,715,784, and Lovins, U.S. Pat. No. 6,296,265. Devices for manipulating a wheelchair especially for the use of dentists, barbers, hairdressers and the like include those described by Petersen in U.S. Pat. No. 4,192,549, McConnell in U.S. Pat. Nos. 4,592,695, 4,726,730 and 4,790,716, Rachman U.S. Pat. No. 4,830,567, Gordon, U.S. Pat. No. 4,941,799, Willey et al U.S. Pat. Nos. 4,834,411 and 6,478,529, Ebersole U.S. Pat. No. 5,007,118, Booth U.S. Pat. No. 5,040,939, Kadlec et al U.S. Pat. No. 5,472,307, Mesa et al U.S. Pat. No. 6,015,256, Lubrano U.S. Pat. No. 6,641,354, and Martin U.S. Pat. No. 6,866,288. Apparatus external to the wheelchair said to be of more general use is described in Qually et al U.S. Pat. No. 4,527,944, Norton U.S. Pat. No. 4,561,823, Petersen U.S. Pat. No. 5,421,693, LeMaster et al U.S. Pat. No. 5,890,869, James U.S. Pat. No. 6,135,480, and Fleigle U.S. Pat. No. 6,224,156. Zimmerman, in U.S. Pat. No. 4,725,188, calls his apparatus a furniture implement for use with a wheelchair. See also Fleigle U.S. Pat. No. 6,273,443 and Galloway et al U.S. Pat. No. 6,585,279, whose devices appear to be specifically for leg rests or extensions.

While many of the above referenced devices appear to be able to tilt the entire wheelchair, I am not aware of a device in the general form of a station or stall that is designed for the wheelchair-bound person to access without assistance, to both recline the back and head and to elevate the lower legs to a position to alleviate the accumulation of fluid in the legs and/or facilitate exercise while remaining in the wheelchair.

### SUMMARY OF THE INVENTION

In one aspect, my invention includes (1) a frame including a back and two sides, adapted to receive a wheelchair moved into it, the wheelchair including a human occupant, (2) means on the frame operable by the human occupant for moving the human occupant from a substantially upright sitting position to a backward-leaning position, and (3) means on the frame, operable by the human occupant, for elevating the lower legs of the human occupant. In another aspect, my invention is such a frame adapted to receive a wheelchair, and a wheelchair of dimensions to fit into the frame, optionally including latches or other devices for securing the wheelchair in position in the frame, and optionally including electrical contact or switch devices for activating controls for articulation, lower leg elevation and the like readily operable by the wheelchair occupant. In this variation, the wheelchair may include an articulation between its seat and its back member and apparatus on the frame for manipulating the back and seat to effect a reclining or semireclining position for the occupant and/or to elevate the pelvis relative to the head and feet to achieve a lying-down or supine position. In addition, the wheelchair is constructed so that, although the wheelchair may include support for the feet, the feet and lower legs of the occupant may be elevated by a mechanism on the frame. In each aspect or variation, controls for the apparatus are available to the occupant either on the frame only or by connection on the wheelchair; for this purpose, placing the wheelchair into the frame in the fully engaged position will necessarily establish all the electrical and mechanical connections necessary to permit activation of the motor or motors and other devices necessary to effect the desired movement of the occupant while he or she is in the wheelchair, which in turn is in the frame. Desirably, the frame is upholstered and can be an aesthetically pleasing piece of furniture. The frame may be equipped with an electrical connection for recharging a battery on the wheelchair, a separate headrest, television controls, and the like.

Thus my invention includes, separately, a frame for receiving a wheelchair, which I call a wheelchair station, and the combination of the wheelchair station with a wheelchair specially designed for use with it. Healthcare professionals working in nursing homes, hospitals and the like will recognize that one wheelchair station may readily serve a number of patients in wheelchairs.

### BRIEF DESCRIPTION OF THE DRAWINGS

FIG. 1A is a perspective view of my wheelchair station in outline.

FIG. 1B is a more or less diagrammatic depiction of the same wheelchair station, turned to illustrate the leg lift mechanism, and tilt mechanism, from the right side of the station. FIG. 1C is from the rear of the station, providing a further outline of the operation of the leg lift mechanism. Also in outline, FIG. 1D shows some of the mechanism from the left side of the station. FIG. 1E provides details of a stepped lift for lifting the legs.

FIGS. 2A and 2B are overhead outline views showing a wheelchair before and after backing into the wheelchair station, also to illustrate the reclining mechanisms; FIG. 2C provides a back view to highlight the reclining mechanisms. FIG. 2D is a two-part outline drawing showing the correspondence of the wheelchair to parts of the wheelchair station.

FIGS. 3A and 3B illustrate a preferred mechanism for elevating the lower legs while the occupant is in the wheelchair and the wheelchair is in the station. FIG. 3B includes certain parts duplicated in separation from the main drawing to clarify how they fit in the assembly. FIGS. 3C and 3D show a gear box in the engaged and disengaged modes, and FIGS. 3E and 3F illustrate the ability of my leg elevating mechanism to assist a patient from the floor level into a full sitting position at wheelchair seat height.

FIGS. 4A, 4B, 4C, and 4D show the tilting of the entire wheelchair, including the occupant, while the wheelchair is in the wheelchair station. In FIG. 4C, the person's head is lower than his feet.

### DETAILED DESCRIPTION OF THE INVENTION

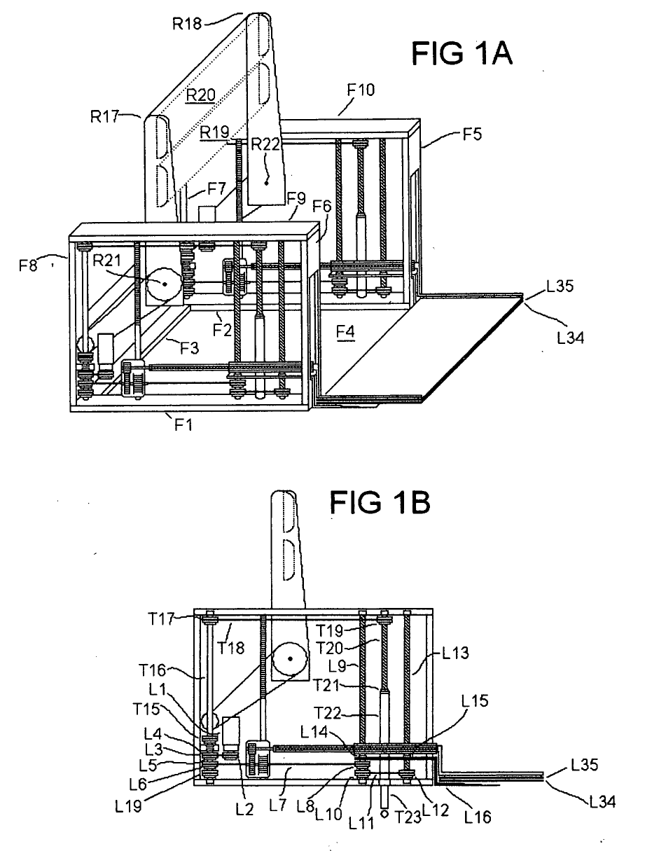

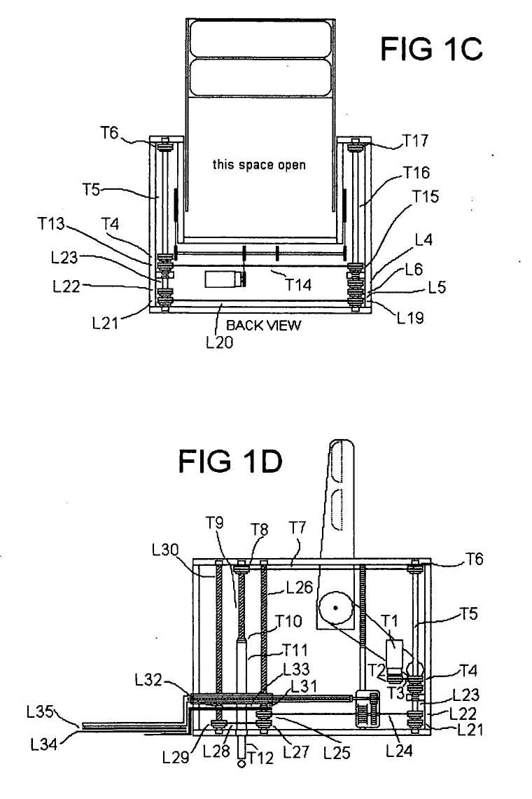

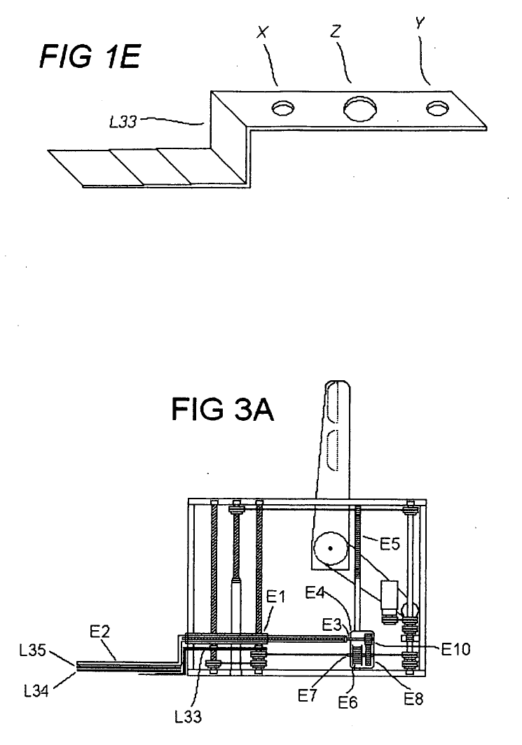

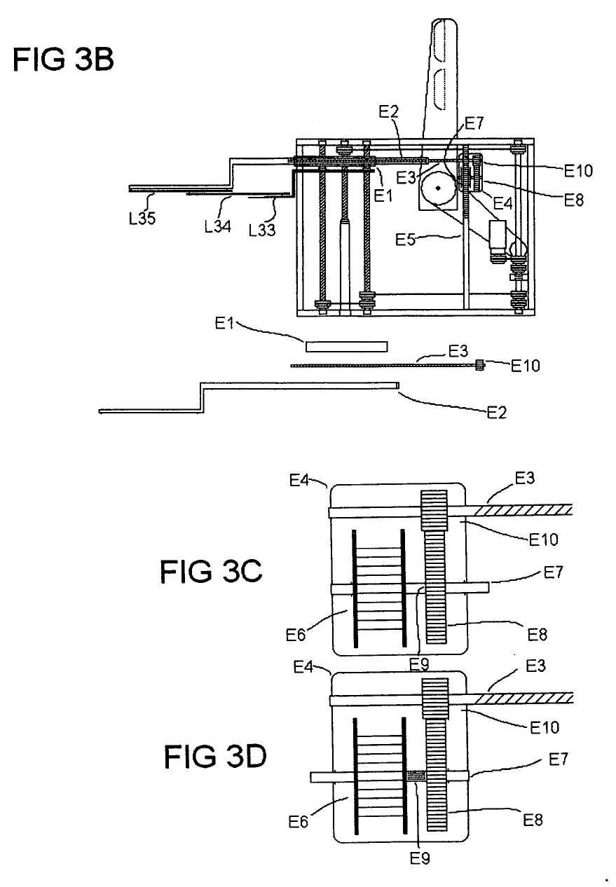

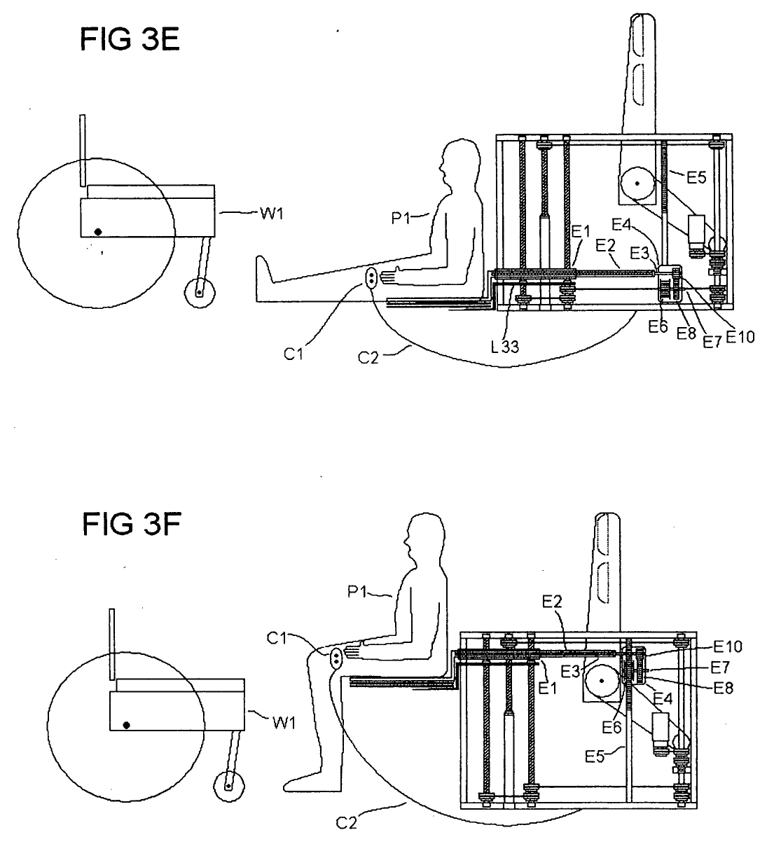

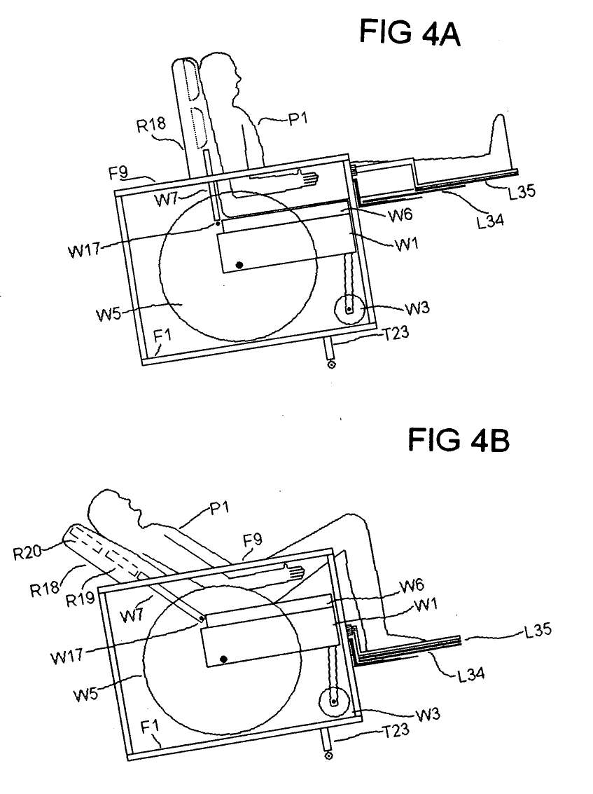

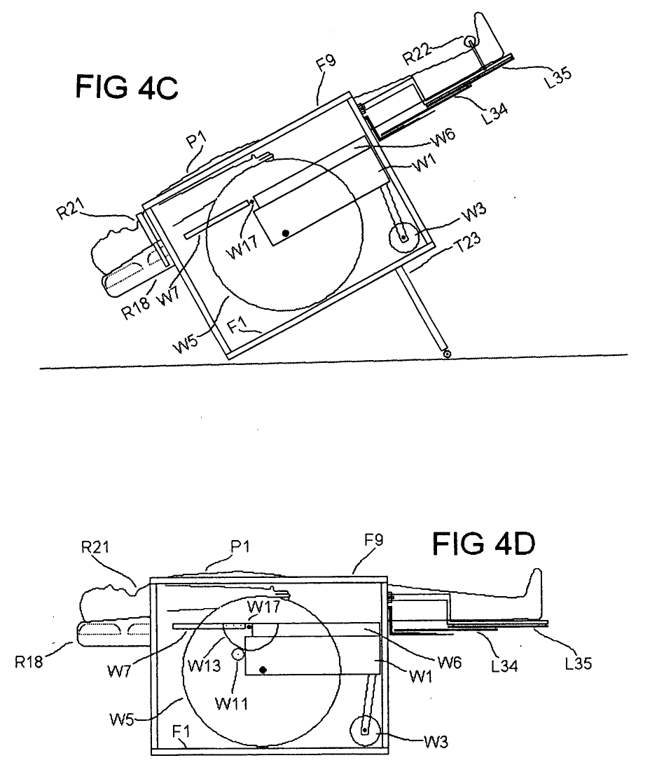

In FIG. 1A, the wheelchair station is seen to comprise a framework having side base members F1 and F2 and back base member F3, the base members F1, F2 and F3 defining a generally rectangular open area F4 which may include a base or floor for supporting the wheelchair when the wheelchair station is tilted, as will be illustrated. The framework also includes left and right front upright members F5 and F6 and back upright members F7 and F8. Arm F10 rests on and connects back upright member F7 and front upright member F5, and arm F9 rests on and connects back upright member F8 and front upright member F6, forming left and right rectangular side frames. An extending footrest comprising panels L34 and L35 (illustrated in more detail in FIGS. 3A and 4A and elsewhere) is approximately at floor level in the entrance to open area or base F4.

FIG. 1A also shows back support R19 of the wheelchair station, headrest R20, and pulley pivot R21, by which back support R19, also utilizing pivot R22, may be pivoted backwards, as will be seen. Headrest R20 may include cushions positioned so that they will extend forward from the vertical plane in which pivot R21 resides, thus providing some height to the occupant's head when in the supine position. Back support R19 and headrest R20 are connected at each end to uprights R17 and R18.

The framework of the wheelchair station is generally dimensioned so that a wheelchair can back into the entrance of open area or base F4, passing over panels L35 and L34. Side base members F1 and F2 may act as a guide for the wheelchair to back into open area F4.

### Elevation of the Feet.

FIG. 1B presents a view of the right side of the wheelchair station. It is to be understood that when a wheelchair is in place within the wheelchair station, one may frequently desire to elevate the feet of its occupant. For this purpose, a motor L1 is activated by a control, such as a button, switch or the like, not shown, readily accessible to the wheelchair occupant—for example fixed in arm F10 or in a portable control panel on a wired tether, not shown. Motor L1 is a speed controlled, reversible, electric motor that rotates pulley L2 mounted on the main shaft of motor L1. Pulley L2 turns a series of pulleys and shafts to rotate threaded rods L9 and L13, which will raise stepped foot elevator L16 and a similar foot elevator, not seen, on the left side of the wheelchair station. Pulley L2 turns belt L3 which turns pulley L4 on shaft L5, which causes pulleys L6 and L19 to turn. Pulley L6 turns belt L7 which drives pulley L8; pulley L8 is key connected to turn threaded rod L9 and, by extension, through pulley L10, belt L11, and pulley L12, to threaded rod L13. Threaded rods L9 and L13 pass in threaded relation to stepped foot elevator L16, so that when the threaded rods L9 and L13 are turned synchronously, they will raise stepped foot elevator L16 evenly, maintaining it in a horizontal orientation. It should be understood that sprockets may be substituted for pulleys in this construction and chains or gear trains substituted for belts. Any conventional method of motion transmission may be used throughout this description to use the motor or motors to move the parts as discussed. To facilitate the operation of threaded rods L9 and L13 on stepped foot elevator L16, threaded flanges L14 and L15 may be welded or otherwise fastened to stepped foot elevator L16.

Referring now to FIGS. 1C and 1D, viewing the back of the wheelchair station in FIG. 1C and its left side in FIG. 1D, while motor L1 (see FIG. 1B) operates as described above it also turns pulley L19, causing belt L20 to turn pulley L21, which operates a series of pulleys and belts (shaft L23, pulley L22, belt L24, pulley L25, belt L28 and pulley L29) similar to those on the right side of the wheelchair station, to raise stepped foot elevator L33. Similar to the stepped foot elevator L16, stepped foot elevator L33 has threaded flanges L31 and L32, through which pass threaded rods L26 and L30 respectively. Thus the action of the motor drive on the left side of the wheelchair station is substantially the same—that is, complementary—to its action on the right side, and the two stepped foot elevators L16 and L33 will be raised at the same rate and to the same level simultaneously as manipulated by the occupant of the wheelchair. Again, it should be understood that any series of gears, sprockets, chains, or other drive mechanisms that will accomplish this desired result may be substituted for the pulleys and belts described.

FIG. 1E is a perspective view of stepped foot elevator L33, showing holes x and y which are threaded (threads not illustrated) so the rotation of threaded rods L9, L13, L26, and L30, which pass through holes x and y, (stepped foot elevator L16 also has threaded holes x and y) will raise or lower the stepped foot elevator L16 or L33. The threaded holes x and y may be reinforced with threaded flanges attached to them, such as threaded flanges L31 and L32 illustrated in FIG. 1D. Larger hole z permits telescoping tilting device T11 (see FIG. 1D) to pass through without impairing the movement of the stepped elevator, as will be discussed further below.

In FIGS. 3A, 3B, operation of the leg lifting mechanism is illustrated. As indicated in the above discussion, stepped foot elevators L16 and L33 can be elevated by the rotating action of threaded rods L9, L13, L26 and L30. Viewed now from the left side of the wheelchair station in FIG. 3A, a gear box E4 is seen at the right end of stepped member E2, with rack gear E5 passing through it. Stepped member E2 is hollow and internally threaded in its higher portion, to accommodate threaded rod E3 inside it. Stepped member E2 itself passes into and through tube E1. As the entire foot rest assembly is elevated by the rotating action of threaded rods L9, L13, L26 and L30, gear box E4 is elevated along with it. The lower portion of rack gear E5 is not threaded, but the upper portion, as illustrated, has teeth for engaging a small gear E10 on the end of threaded rod E3. As small gear E10 engages rack gear E5 during its ascent, threaded rod E3 is turned, causing stepped member E2 to extend, carrying foot panel L34 along with it. See FIG. 3B. Panel L34 is still supported by panel L33. In the more detailed illustrations of gear box E4 in FIGS. 3C and 3D, it is seen that the threaded rod E3 is turned when the teeth E9 of threaded rod E7 are engaged with gear E10 as shown in FIG. 3C but not when disengaged as shown in FIG. 3D. As seen in FIG. 4A, this enables the occupant, P1, to extend his or her legs horizontally. FIGS. 3C and 3D also provide an enlarged view of flanged gear E6; see FIGS. 3E and 3F to observe how the flanges help retain the gear in place as the leg lifting portions of my invention are activated to raise the legs and, in the case of FIGS. 3E and 3F, the wheelchair-bound person in need of elevating to the sitting position on the wheelchair W1.

### The Reclining Features.

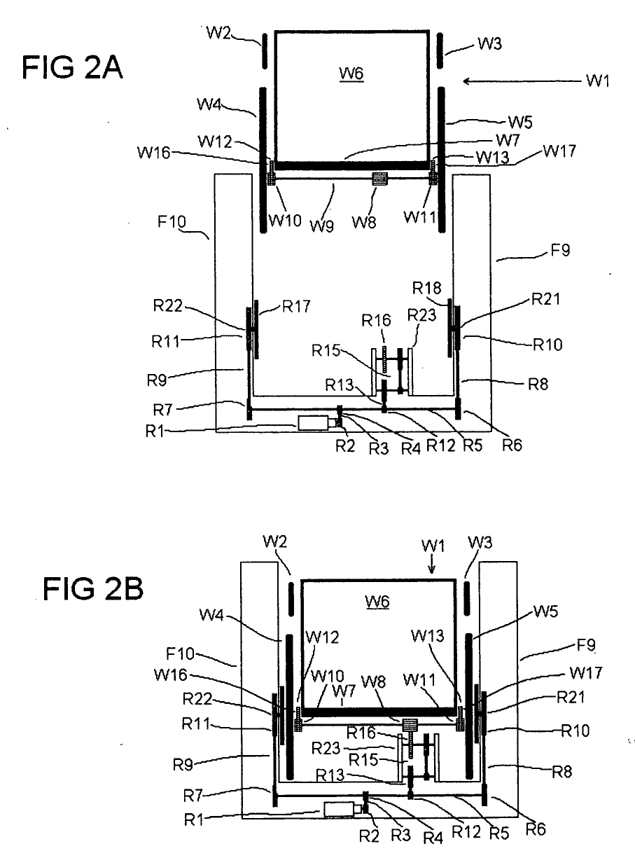

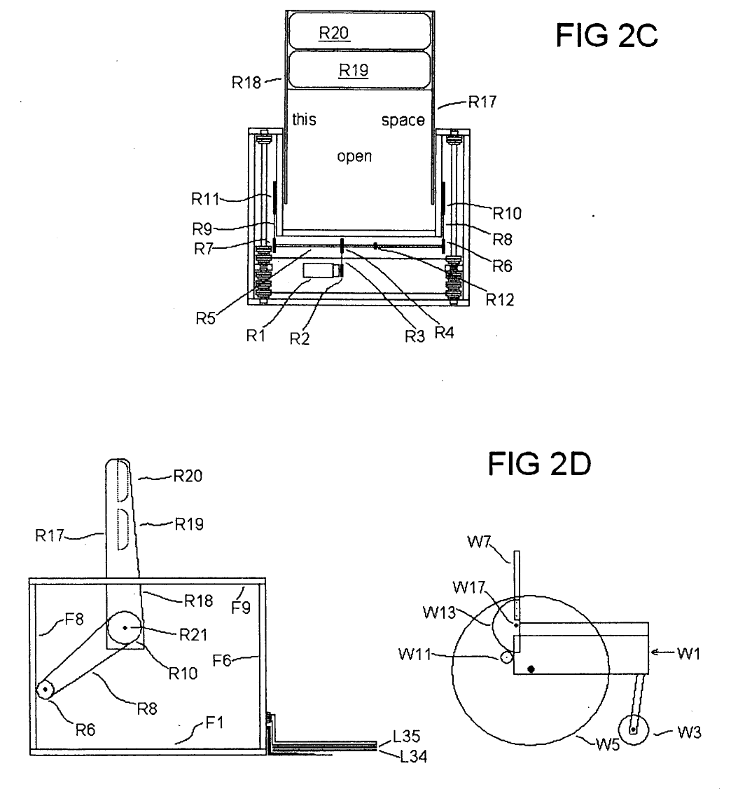

In FIG. 2A, looking down from overhead, the outline of a wheelchair is seen adjacent to and in front of the wheelchair station preparatory to entering it. Arms F9 and F10 are seen as part of the wheelchair station framework, and may act as a guide for the backward motion of the wheelchair into the station. The wheelchair W1 comprises front wheels W2 and W3, larger back wheels W4 and W5, seat W6, backrest W7, and gear W8 on shaft W9. When wheelchair W1 is fully backed into position in the wheelchair station, gear W8 will mesh with gear R16 which is driven by motor R1 through pulley R2, belt R3, pulley R4, shaft R5, pulley R12, belt R13 and gears not detailed within gear box R23. Also on shaft W9 are gears W10 and W1, meshed with gears W12 and W13 respectively for pivoting backrest W7 which functions as a pivot for the backrest (not shown) of the wheelchair, to place it in a reclining or semi-reclining position. FIG. 2A also shows, from overhead, uprights R17 and R18, which are turned on pivots R21 and R22 by the power transmission trains R6, R8, and R10 on the right side and R7, R9, and R11 on the left of the wheelchair station.

In FIG. 2B, again from overhead, the wheelchair has backed completely into the wheelchair station, and it is seen that gear R16 in gearbox R23 has meshed with gear W8 on the wheelchair, and the mechanisms will operate as described above. In one version of my invention, a circuit will also be completed when the wheelchair is completely within the wheelchair station and the gears are meshed, thus activating all the controls, which will not otherwise operate. Any conventional circuit-completing device may be used for this purpose.

Referring now to FIG. 2C, the wheelchair station is viewed from behind to continue the illustration of the reclining features of the wheelchair and station combination. FIG. 2C is similar to FIG. 1C, except that the reclining mechanisms previously shown in FIG. 2B from above are now seen from behind. Again, motor R1 activates belt R3, turning pulley R4, ultimately tilting the uprights R17 and R18, through the chain of gears, pulleys and the like. See the description of FIG. 2B.

FIG. 2D is an outline/conceptual figure showing the relationship of the wheelchair W1 and the wheelchair station, from the right side. The wheelchair W1 has a back W7 which, as will be seen in FIG. 4B, nests under back support R19 of the wheelchair station and may tilt in coordination with uprights R17 and R18 to achieve any posture for the occupant from sitting upright to supine. Pulleys R6 and R10, operating on belt R8, will accomplish the appropriate tilt after the occupant operates the controls (not shown) accordingly.

Turning to FIG. 1D to look at the tilting features of the invention, a separate, reversible, motor T1, again under the control of the occupant of the wheelchair by any suitable means, may be used for tilting the entire wheelchair station. It is connected by any suitable power transmission components to extend shaft T12 downwardly, thus elevating the front end of the wheelchair station, and tilting it, as seen in FIG. 4A. Illustrated are pulley T2, turned by motor T1, which turns belt T3 and thereby pulley T4 mounted on shaft T5, able to rotate pulley T6, transmitting the rotation to belt T7 connected to pulley T8, key connected to threaded rod T9, engaged with threaded flange T10 on telescoping tilting device T11 actuating the shaft T12 to extend or retract it. As shaft T12 is extended, the wheelchair station is tilted; see FIG. 4A. It should be understood that, if the wheelchair station is to be built without the tilting feature, of course tilting device T11, shaft T12, and base F4 will not be necessary along with the elements to activate them, nor will it be necessary to have a hole z as shown in FIG. 1E.

FIG. 4B illustrates a combination of the reclining feature, wherein upright R18 is pivoted backward at about 45 degrees, foot panels L34 and L35 are partially elevated, and shaft T23 (seen on the right side of the wheelchair station) is extended to tilt the entire wheelchair station. Note that wheelchair back W7 is pivoted on pivot W17 (see the opposite pivot W16 in FIG. 2A) In FIG. 4C, the occupant P1 has not only achieved the supine position, but his entire body is tilted to elevate the legs. Shoulder arrest R21 assures that the patient will not slide out of the wheelchair; it may be a permanent fixture or may be emplaced temporarily by the patient, and may be supplemented by a restraint R22 around the ankles. Note that the wheelchair back W7 is on substantially the same level as the station upright R18. FIG. 4D is a similar view in which the wheelchair station is not tilted.

### The “Rescue” Features

In FIGS. 3E and 3F, it is seen how my invention, particularly the leg elevating features, can be used to elevate a person from the floor, where he or she may have fallen, onto a wheelchair. A person not having the use of his or her legs could nevertheless achieve a sitting position on the stepped foot elevators L33 and L35, and control his or her elevation without activating the foot extension mechanisms. For this purpose, a hand-held control console C1 is recommended—that is, a control panel, not shown, which is not fixed on the wheelchair station but is connected by flexible wires C2 or cable to the wheelchair station and is always within reach from the floor as well as from a sitting position. Of course, such a panel may be convenient for other reasons as well. From the position shown in FIG. 3F, the patient may be able to achieve access to the wheelchair, reach a telephone, or otherwise provide for himself or herself far more capably than if he or she were lying helpless on the floor.

My wheelchair station is seen to contain a number of relatively heavy components, such as motors, gears, shafts and the like that would otherwise add weight to the wheelchair if the same or similar capabilities were to be built directly into the wheelchair. Therefore, when the wheelchair is mobile and hand-powered by the occupant or pushed by others, it can remain at a low weight, while the mechanisms for reclining and lifting the lower legs are in the station, which can be permanently connected to an electrical power source, giving the occupant independent control over the functions of foot elevation, reclining even to the horizontal, and tilting of the entire assembly. Even if the wheelchair is battery-powered and contains not only a battery but motors, it will not be burdened with the additional weight and construction of the levers, gears, and perhaps more motors to accomplish the reclining, elevating, and tilting results of my wheelchair station.

Thus it is seen that my invention includes a station for a wheelchair comprising (1) a frame including a back and two sides, the frame defining a front opening dimensioned to receive a wheelchair moving backwards into it, the wheelchair including a human occupant, (2) back support means on the frame for supporting the head of the human occupant in a reclining or supine position while on the wheelchair in the station, and (3) means on the frame for elevating the feet of the human occupant while on the wheelchair in the station.

In another aspect, my invention includes apparatus for lifting the feet of a person in the sitting position on a chair comprising (a) a frame including side members placed to be on each side of the chair when the chair is present, (b) a foot rest placed to be in front of the chair when the chair is between the side members, (c) means operable by the person when on the chair either manually or by electric power to raise and extend the foot rest to support the feet in a raised and extended position.

In another aspect, my invention includes a wheelchair station comprising (1) a frame including a back and two sides, the frame defining a front opening dimensioned to receive a wheelchair moving backwards into it, (2) a wheelchair in the wheelchair station facing outwardly through the opening, (3) means within the wheelchair station for tipping the wheelchair backwards, and (4) means within the wheelchair station for lifting the feet of an occupant of the wheelchair independently of the means for tipping.

In yet another aspect, my invention includes a wheelchair station having a wheelchair therein, the wheelchair including a wheelchair back, a seat and articulating means between the back and seat, the wheelchair station including a foot rest for a human occupant, the wheelchair station comprising a frame and two sides forming an open end, at least one of the two sides including control means operable by a human occupant in the wheelchair, the control means including means for operating at least one of (a) reclining means for changing the relative height of the head and the pelvis of a human occupant of the wheelchair, the reclining means including means utilizing the articulating means, and (b) means for elevating the foot rest.

Persons skilled in the art of wheelchair patient care will also recognize that electrically operated vibrators may be installed on the foot rest or elsewhere in the wheelchair or wheelchair station to aid in circulation and in the reduction of fluid accumulated in the legs of the patient. On-off switches and/or devices for varying the degree of vibration may be provided on the hand-operated console. Also, it is seen that many existing wheelchairs could be retrofitted to fit and work within the wheelchair station, as well as being built new. The manufacturers of the wheelchairs can readily supply retrofit kits with the parts and/or tools to make any necessary changes. A wheelchair designed to fit in a wheelchair station may include devices manually operated independently of the station to permit the occupant to recline for medical, dental, or cosmetic purposes.

1. A station for a wheelchair comprising (1) a frame including a back and two sides, said frame defining a front opening dimensioned to receive a wheelchair moving backwards into it, said wheelchair including a human occupant, (2) back support means on said frame for supporting the head of said human occupant in a reclining or supine position while on said wheelchair in said station, and (3) means on said frame for elevating the feet of said human occupant while on said wheelchair in said station.

2. The station of claim 1 wherein said means (3) are operable by said human occupant by electric power.

3. The station of claim 1 including means for tipping said station while said wheelchair is within it, to achieve a reclining or supine position for said human occupant of said wheelchair.

4. The station of claim 1 wherein said back support means (2) includes a pivot for pivoting said support means (2) to a reclining or supine position.

5. The station of claim 4 wherein said pivoting is accomplished by said human occupant by electric power when the wheelchair is in said station.

6. The station of claim 1 including a base member within said frame for supporting a wheelchair in said station.

7. The station of claim 1 wherein said means (3) for elevating the feet are operable by said human occupant either manually or by electric power.

8. The station of claim 1 which is upholstered.

9. The station of claim 1 including at least one guide for guiding said wheelchair backwards into said station.

10. The station of claim 9 including a station base and wherein said at least one guide is on said base.

11. The station of claim 1 including a circuit-completing device for activating an electric power circuit, said circuit-completing device permitting said support means (2) to operate only when said wheelchair is properly within said station.

12. The station of claim 1 including a circuit-completing device for activating an electric power circuit, said circuit-completing device permitting said feet elevating means (3) to operate only when said wheelchair is properly within said station.

13. Apparatus for lifting the feet of a person in the sitting position on a chair, said chair being separable from said apparatus, said apparatus comprising (a) a frame including side members placed to be on each side of said chair when said chair is present, (b) a foot rest placed to be in front of said chair when said chair is between said side members, (c) means operable by said person when on said chair either manually or by electric power to raise and extend said foot rest to support said feet in a raised and extended position.

14. Apparatus of claim 13 wherein said chair is a wheelchair and said means operable by said person to raise and extend said foot rest are built into said frame and are controllable by said person while sitting in said wheelchair.

15. Apparatus of claim 13 wherein said foot rest comprises at least two panels, one of which can extend farther than the other.

16. A wheelchair station having a wheelchair therein, said wheelchair being independently movable from said wheelchair station, said wheelchair including a wheelchair back, a seat and articulating means between the back and seat, said wheelchair station including a foot rest for a human occupant when seated in said wheelchair, said wheelchair station comprising a frame and two sides forming an open end, at least one of said two sides including control means operable by a human occupant in said wheelchair, said control means including means for operating at least one of (a) reclining means for changing the relative height of the head and the pelvis of a human occupant of said wheelchair, the reclining means including means utilizing said articulating means, and (b) means for elevating said foot rest.

17. A wheelchair station of claim 16 wherein said station back comprises an upper back support and a head rest and is shaped to permit said wheelchair back to nest within it.

18. A wheelchair station of claim 16 wherein said station back and said wheelchair back remain nested when in the supine position.

19. A wheelchair station of claim 16 including means for tipping said wheelchair.

20. A wheelchair station of claim 19 wherein said means for tipping include means for tipping said wheelchair station.
